(19) United States
(12) Patent Application Publication
(10) Pub. No.: US 2006/0237052 A1
(43) Pub. Date: Oct. 26, 2006

(54) Computer-controlled system for dishwashers

(75) Inventors: John Patrick Picardat, Greenwood, MS (US); David Clinton Weaver, Greenwood, MS (US); Jerry Wayne Ferguson, Greenwood, MS (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Viking Range Corporation

(21) Appl. No.: 11/170,252

(22) Filed: Jun. 29, 2005

Related U.S. Application Data
(60) Provisional application No. 60/674,482, filed on Apr. 25, 2005.

(51) Int. Cl. B08B 7/04; B08B 3/00; B08B 9/20; B08B 3/04

(52) U.S. Cl. 134/56 D; 134/58 D; 134/18; 134/25.2; 134/104.2; 134/10; 134/34

(57) ABSTRACT

A method and system for dynamically controlling operation of a dishwasher during a cleaning cycle. The method includes detecting a plurality of conditions in the dishwasher during operation, evaluating the plurality of detected conditions to determine a dynamic control response, and sending a signal representing the dynamic control response to at least one component of the dishwasher. The plurality of detected conditions can include some or all of a rate of change of a wash water temperature, an approximate surface area and thermal mass of a plurality of dishes loaded in the dishwasher, an amount of wash water added to the dishwasher and a status of a full flow filter. The control system includes means for detecting a plurality of conditions in the dishwasher during operation, means for evaluating the plurality of detected conditions to determine a dynamic control response, and means for sending a signal representing the dynamic control response to control at least one component of the dishwasher.

### CROSS-REFERENCE TO RELATED APPLICATION

This application claims the benefit of U.S. Provisional Application 60/674,482, filed Apr. 25, 2005, incorporated by reference herein in its entirety.

### BACKGROUND OF INVENTION

The present invention relates generally to dishwasher control systems and, more particularly to a dishwasher having a program-controlled controller providing dynamic control of dishwasher operation.

Most dishwashers known in the art use some sort of electrical microprocessor or electromechanical device to control the functional components of the dishwasher. These components most commonly include the pump motor, drain motor, water heating element, water valve, detergent/rinse aid dispenser and often a few design-specific components such as electrically operated valves, etc. Historically, the most common inputs to these controls have been by the user setting inputs through the user interface control panel, temperature input from thermistors, or thermostats and overflow information from an “overflow float switch”.

The sequence and duration that the control energizes or controls the functional components makes up the dishwasher's wash cycle program. During most of the history of dishwasher development the “wash cycle” program was basically set by user selection and did not change during the course of the cycle to react to conditions inside of the machine. The one exception has been a water heater thermostat which, when a predetermined water temperature inside the dishwasher was reached, would cut off power to the water heater and/or allow the timing device to advance and end the water heating portion of the cycle.

Many dishwashers known in the art use sensor input to the dishwasher's controller in an attempt to tailor the wash cycle to the conditions which actually prevail inside of the machine. The most common type of sensor inputs are from temperature sensors, and more recently “turbidity” sensors which determine how soiled the wash water is at any given point in the wash cycle.

U.S. Pat. No. 6,694,990 to Spanyer discloses a dishwasher operating method which collects information from a temperature sensor in the dishwasher tub and includes a sensor which detects the amount of rinse agent present in the rinse aid dispenser. Once this information is input into the dishwasher's controller an optimized heating element and drying fan cycle are determined.

U.S. Pat. Nos. 6,007,640 and 5,957,144 to Neff disclose a dishwasher which uses a “turbidity” sensor to determine how soil laden the wash water has become during the overall wash cycle. If the amount of soil determined to be in the wash water is below a threshold value, the drain motor and water valve are disabled to prevent the water from being drained and to prevent additional water from being introduced into the dishwasher. In theory, since the water is already relatively clean the additional dilution gained by draining the wash water and adding fresh wash water is not needed and therefore can be skipped. If the sensed turbidity is correct, the dishes will still be acceptably clean by the end of the overall water cycle without using as much water as would be the case with the additional drain and fill phases.

U.S. Pat. No. 5,792,276 to Driessen discloses a dishwasher which measures the temperature of the incoming water. The temperature information from the incoming water is used to determine a duration for the rinse and water heating cycle. If the dishwasher was connected to cold water, it could take a very long time for the water to reach the desired temperature. Because the dishwasher runs so long heating the water, it may not be necessary to extend the length of the rinse cycle once the temperature is attained. This invention therefore has the potential to shorten the wash cycle without lessening the wash performance when the machine is connected to water supplies which vary greatly in temperature.

U.S. Pat. No. 5,725,001 to Vogel discloses a dishwasher which uses a pH probe to determine the level of acidity of the wash water. A wash program is then selected by the machine controller based on the level of acidity detected by the pH probe. The pH can be controlled by adding detergent as necessary.

U.S. Pat. Nos. 5,408,716; 5,313,964; and 5,284,523 to Dausch, et al. disclose methods for determining the minimal amount of water required for a dishwasher pump to operate without drawing air into the pump inlet. The dishwasher either directly monitors pressure oscillations from the pump discharge or indirectly monitors the pressure oscillations by monitoring the behavior of the pump motor in order to determine when enough water has been added to the dishwasher. If there is not enough water in the machine there will be a characteristic pressure oscillation of the pump. When enough water has been added to keep the pump fully primed at all times, the pressure oscillations will subside. Once the pressure oscillations subside the water valve is turned off by the dishwasher controller.

U.S. Pat. No. 4,673,441 to Mayers discloses a dishwasher with a sensor in the soil collection chamber which is responsive to a predetermined particulate soil concentration in the chamber. If the soil concentration is above a predetermined value, a wash cycle designed for heavy soil concentration will be selected by the machine controller.

Most dishwasher controllers are unable to detect and react to many variables/conditions inside the dishwasher such as the surface area and thermal mass of dishes loaded into the dishwasher; the rate of change of the water temperature; the amount of food soil introduced into the dishwasher; the exact amount of water present in the dishwasher; and whether or not the “full flow” filtration system is allowing enough water to pass for the wash pump to operate at peak efficiency without losing prime.

Therefore, the wash cycle must be designed or “pre-programmed” to accommodate worst case conditions with respect to these variables. Programming the controller for the worst case conditions will insure the dishwasher will perform well if these worst case conditions are ever encountered by the consumer. The drawback of this “worst case, pre-programmed” approach is that it is wasteful of water, energy and time.

Some dishwashers known in the art collect some information that attempts to measure some of these variables, either directly or indirectly. For example, the use of turbidity sensors can determine how clean the wash water is by sensing the turbidity of the water and a thermistor can provide temperature readings during the water-heating portion of the cycle. Currently none of the controls known in the art combines these many variables to optimize the cycle for high wash performance at the lowest possible water and energy usage.

If a dishwasher controller could measure and evaluate these variables together, either directly or indirectly, a dishwasher controller could be programmed to change the sequence and duration of the functional components of the dishwasher in order to allow the dishwasher to use less energy, water and time when conditions are more favorable than the worst case conditions. By far, most of the conditions encountered during the life of the dishwasher will be much less than worst case. Over the life of the machine the savings in water, energy and time from the dishwasher cycle detecting and reacting to these variables would be significant.

### SUMMARY OF THE INVENTION

This invention uses a logical algorithm contained within the dishwasher's microprocessor controller to process information from the motor controller, thermistor (temperature sensor), and fill level/volume detector.

Once the information from these sensors and sources are collected the microprocessor can determine several key states within the machine and then react by changing the wash program in real-time. The real-time changes made to the wash system tend to minimize or (optimize) the cycle time, water usage and wash performance. Information collected also allows the microprocessor to determine if overflow or overheating conditions exist inside the machine and then react to correct those conditions.

In one aspect of the invention a dishwasher is provided having a pump for discharging water into a dishwasher tub; a motor coupled to the pump to drive the pump during dishwasher operation; a motor controller operationally connected to the motor to control a speed of operation of the motor and to determine a full flow filter condition; and a dishwasher controller operationally connected to the motor controller and including programming logic for dynamically controlling the operation of the dishwasher in response to a plurality of conditions detected in the dishwasher during operation.

The dishwasher can include a detector means that determines a fill level of the wash water in the dishwasher tub and provides the fill level to the dishwasher controller. A thermistor can determine the temperature of the wash water in the dishwasher tub and provide the determined temperature to the dishwasher controller. The dishwasher can further comprise means that determines an approximate surface area and thermal mass of a plurality of dishes loaded in a rack of the dishwasher tub and provides the determined approximate surface area and thermal mass to the dishwasher controller. The dishwasher controller programming logic receives and evaluates input signals representing the plurality of conditions detected, and determines if a condition that is detected requires a dynamic change in a controlled function. The dishwasher controller can evaluate fewer or more than the aforementioned conditions in determining whether to change any operational aspects of the dishwasher cycle dynamically.

In another aspect of the invention a method is provided for dynamically controlling operation of a dishwasher during a cleaning cycle and includes the steps of detecting a plurality of conditions in the dishwasher during operation; evaluating the plurality of detected conditions to determine a dynamic control response; and sending a signal representing the dynamic control response to at least one component of the dishwasher. The plurality of detected conditions can include some or all of a rate of change of a wash water temperature, an approximate surface area and thermal mass of a plurality of dishes loaded in the dishwasher, an amount of wash water added to the dishwasher and a status of a full flow filter.

In another aspect of the invention, a control system is provided for dynamically controlling operation of a dishwasher during a cleaning cycle. The apparatus includes means for detecting a plurality of conditions in the dishwasher during operation, means for evaluating the plurality of detected conditions to determine a dynamic control response, and means for sending a signal representing the dynamic control response to control at least one component of the dishwasher.

### BRIEF DESCRIPTION OF THE DRAWINGS

The invention is better understood by reading the following detailed description of the invention in conjunction with the accompanying drawings.

FIG. 1 illustrates an operational view of a dishwasher motor/pump system used in an exemplary embodiment of the invention.

FIG. 2 illustrates exemplary inputs and outputs for the controller of the present invention.

FIG. 3 illustrates processing logic executed by the controller in accordance with an exemplary embodiment of the invention.

### DETAILED DESCRIPTION OF THE INVENTION

The following description of the invention is provided as an enabling teaching of the invention in its best, currently known embodiment. Those skilled in the relevant art will recognize that many changes can be made to the embodiments described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and may even be desirable in certain circumstances and are a part of the present invention. Thus, the following description is provided as illustrative of the principles of the present invention and not in limitation thereof, since the scope of the present invention is defined by the claims.

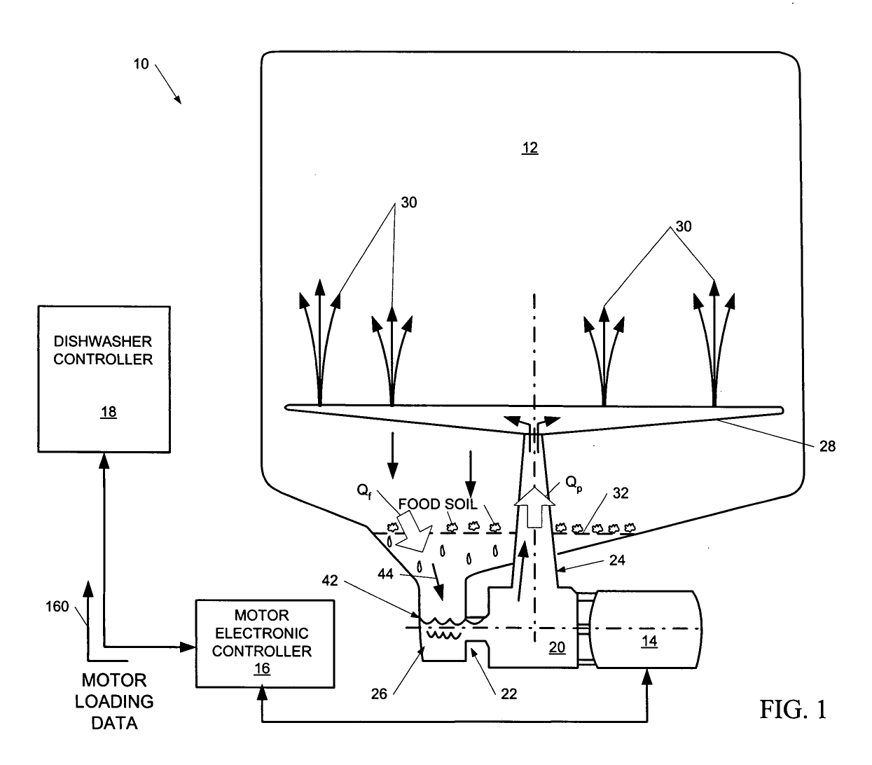

FIG. 1 illustrates an operational view of a dishwasher motor/pump system in an exemplary embodiment. A dishwasher 10 includes a dishwasher tub 12 that is capable of receiving dishes in trays (not shown) and includes a motor 14 that controls a pump 20. The motor 14 is connected to a motor electronic controller 16, which, in turn, is connected to a dishwasher controller 18. The pump 20 has a pump suction inlet 22 that receives water from the dishwasher tub. The pump also has a pump discharge 24, which generally is positioned above the pump, and is connected to a spray arm 28. Water from the dishwasher tub 12 is suctioned by the pump 20 through the pump suction inlet 22 and forced through the pump discharge 24 to the spray arm 28. The spray arm 28 then disperses the pumped water into the dishwasher tub 12 through water jets 30. The water jets 30 are disposed along the spray arm 28 and can include any number or configuration that allows the pumped water to be dispersed to dishes or other items in the dishwasher tub 12 to remove debris or other food/soil on the dishes during operation of the dishwasher.

Water from the dishwasher tub 12 normally collects towards the bottom of the tub 12 into sump 26 under the force of gravity. The sump 26 is connected to the pump suction inlet 22 to allow water to be communicated from the dishwasher tub 12 into the pump 20. The sump 26 can be of any form and merges with the pump suction inlet 22 to allow a large enough volume of water to proceed therethrough at a rate dictated by the pump 20. The filter 32 generally is disposed in the dishwasher tub 12 above the sump 26. The filter 32 spans the opening above the sump 26 to filter all water received in the sump 26 through the pump suction inlet 22 into the pump 20. The filter holes in this full-flow filter 32 generally are formed smaller than conventional filters, which are designed for a worst-case soil load.

The present invention provides a control algorithm or program for a dishwasher which operates by detecting the following variables/conditions:
a) whether or not the “full flow” filtration system is allowing enough water to pass for the wash pump to operate at peak efficiency without losing prime;
b) the approximate surface area and thermal mass of dishes loaded;
c) the rate of change of the water temperature;
d) the amount of food soil introduced into the dishwasher; and
e) the exact amount of water present in the dishwasher.

Based on evaluating the combination of these variables, the dishwasher controller adjusts the sequence and duration of the functional components in order to minimize the amount of water, energy and time used while maintaining an acceptable level of cleanliness of the dishes at the completion of the cycle.

As additional background for the present invention, units of heat measurement are usually dependent upon experimentally determined properties of some arbitrary substance, usually water. For example, the British Thermal Unit (BTU) is defined as the heat energy necessary to raise one pound of water one degree Fahrenheit at some arbitrarily chosen temperature level. The heat capacity of a material is the amount of heat required to raise a unit mass of the material one degree in temperature. The ratio of the amount of heat required to raise a unit mass of material one degree to that required to raise a unit mass of water one degree at some specified temperature is the Specific Heat (Cₚ). For the purposes of predicting the thermal behavior of a dishwasher, the heat capacity of the materials involved may be assumed to be numerically equal to the specific heat of the materials. The English units for specific heat are BTU/(lb*degF).

Thermal mass is the product of the specific heat of a material multiplied by its mass.
Thermal Mass (THM)=Mass*Cₚ

Thermal mass is a somewhat less used and less general term than specific heat but it is useful when discussing and predicting the amount of energy required to raise the temperature of a dishwasher. The total thermal mass of the dishwasher system is determined by simply adding all of the thermal masses contained in the system's chosen control volume. In the present invention, the best control volume to choose is the outer surface of the dishwasher tub that is enclosed in a thermal insulating blanket.

Once the thermal mass of a system is known and the amount of heat added to the system is also known, the temperature change (T₂−T₁), can be determined by dividing the heat added by the thermal mass:
T₂−T₁=(Net Heat Added)/THM

The net heat added to the system is the energy added through the dishwasher's heating element less the heat lost from conduction through the dishwasher's walls and surfaces to the surroundings. The net heat added is a known value since the duration of heating is known, power provided from the heating element is known as well as the overall heat transfer coefficient for the dishwasher, which is used to calculate the heat loss rate or power loss at any given temperature. The heat loss rate or power loss through the walls of the machine is simply the temperature difference between the ambient air in the room and the temperature inside of the dishwasher multiplied by the overall heat transfer coefficient. The overall heat transfer coefficient for the system can be determined experimentally by letting the dishwasher operate in a controlled environment with a relatively low power setting on the heater (e.g., 500 watts, this relatively low power setting is to prevent the steady state temperature of the system from being at or above the boiling point of water), and allowing the machine to run long enough for the temperature inside of the machine to reach a constant or “steady state” value. Once the machine reaches this steady state the heat rate or power leaving the machine can be assumed to be the same as the heat rate or power being added by the heating element. Once the steady state temperature is known the power escaping the machine, which is the same as the power setting of the heating element at this steady state, can be divided by the temperature difference to determine the overall heat transfer coefficient for the system.

If adding a known power level to the dishwasher system through the heating element for a known period of time results in a lower than expected increase in temperature for the entire system, then it can be concluded by the dishwasher's controller that the system has a relatively high thermal mass and therefore contains a relatively large dish load. On the other hand, if the temperature rise of the wash system is higher than expected then it can be concluded that the thermal mass and therefore the dish load is relatively small.

These calculations assume that the temperature throughout the system is relatively uniform and that the system is “well mixed”. Because a dishwasher is primarily adding heat to the wash water and then constantly spraying and circulating this water throughout the system, the inside of the dishwasher and its contents tend to stay at a uniform temperature. Therefore, the dishwasher can be assumed to be a well-mixed system.

The thermal mass of the dishwasher's structure, walls, racks and other mechanical components comprise a small and constant value when compared to the dish load.

The thermal mass of a plastic dishwasher is significantly higher than that of most stainless steel machines because the specific heat of plastic is so much higher than that of steel. It takes more energy to heat up plastic than metal. This fact makes this method of predicting the size of the dish load less precise in the case of plastic dishwashers because the thermal mass of the machine makes up a larger percentage of the total thermal mass thus making the changes from different size dish loads relatively smaller.

By way of example, the properties for a relatively normal or full dish load can be about the following values:

Mass=30 lbs

Average specific heat=0.2 (BTU/lbm*F)

Thermal Mass=6 (BTU/F)

Approx surface area=4069 in²=28.25 ft²

As a further example, the properties for a relatively small dish load can be about the following values:

Mass=12.5 lbs

Ave Specific heat=0.2 (BTU/lbm*F)

Thermal Mass=2.5 (BTU/F)

Approx surface area=678 in²=4.7 ft²

As can be seen from these examples, the differences in thermal mass and surface area are relatively large between large and small dish loads. Therefore, a great deal of precision is not required in the measurements and assumptions can successfully be made about the average surface area of dish loads and specific heats.

As discussed herein, a significant amount of wash water remains on the surface of the dishes during the wash and is therefore unavailable to the system to keep the pump fully primed and to assist in cleaning the filter. A high thermal mass and therefore surface area of the dishes could warrant the addition of more water to the machine if filter clogging is indirectly detected by a loss of prime in the pump.

Much of the run time required for a dishwasher's main wash phase is needed to heat the incoming wash water, dishwasher structure and dish load. The time spent to accomplish this is usually more than enough time for the spray jet's mechanical action to wash away any loose food soils

During the wash phase most dishwasher cycle designers want the wash system temperature to reach at least 142° F. to 147° F. This temperature range is where most of the stubborn to remove animal fats contained in the soil load on the dishes melt and is often critical to obtaining that “squeaky clean” feel of the dishes.

For example, if the incoming water temperature is 148° F. and the thermal mass in the machine is not very high then it will not be necessary to run the machine as long in order to heat the water. Conversely if the incoming water temperature is relatively low (e.g., 65° F.) and the thermal mass is relatively high the dishwasher will require a much longer time to heat the water to the critical fat melting temperature range.

Because the thermal mass, heat addition and heat loss are known values the time to reach the range when animal fats dissolved can be estimated by the controller. As an example, if the initial heating rate of the wash system is 3° F./min, the controller can then estimate the energy and time required to overcome heat loss to the environment, and heat the system to the desired temperature for the desired amount of time. This calculation can be made early in the cycle, or if more accuracy is desired, it can be updated at different points during the cycle.

As the preceding discussion suggests, the rate of heat loss to the environment increases as the temperature difference between the inside of the machine and the ambient air in the room increases. Because of this the net heat added rate to the machine decreases as the machine becomes hotter.

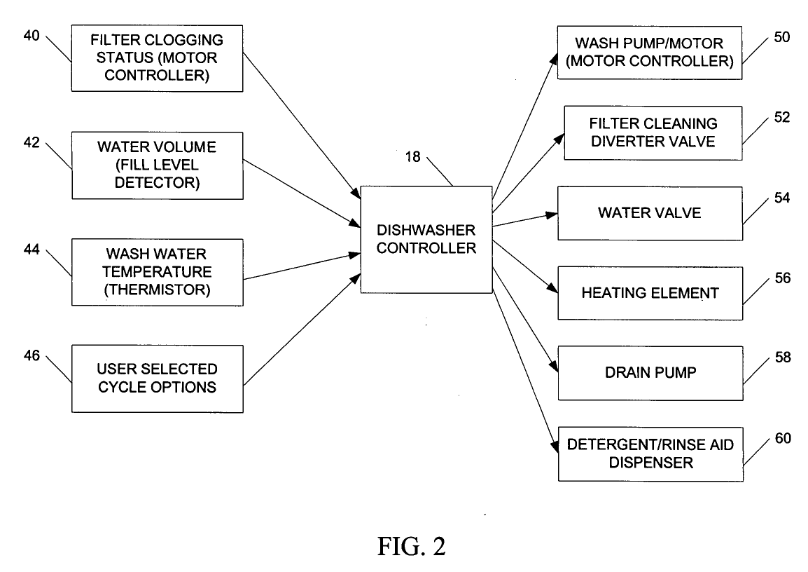

FIG. 2 illustrates inputs to, and outputs from, the dishwasher controller in an exemplary embodiment. The inputs and outputs depicted are exemplary, but not limiting. The filter clogging status 40 (from motor controller 16), water volume (fill level detector) 42, wash water temperature (thermistor) 44 and user-selected cycle options are inputs to dishwasher controller 18. After evaluating these conditions, the dishwasher controller 18 sends signals to adjust operation of the wash pump/motor (motor controller) 50, filter cleaning diverter valve 52, water valve 54, heating element 56, drain pump 58 and detergent/rinse aid dispenser 60.

The signals sent to the motor controller control the motor speed to: (a) start and stop at the beginning and end of cycles; (b) start slowly as water is being added; (c) receive torque data from the motor, which is analyzed to determine if the pump is primed; and (d) stop, slow and start the motor in response to filter clogging logic. The data stream between the motor controller and dishwasher controller is bidirectional. The filter cleaning diverter valve can be opened and closed in order to dedicate more water to the filer cleaning jets. The water valve can be operated on and off as the wash cycle program directs. Input from the level control helps to determine when the valve is to switch off. The heating element can be operated on and off as directed by the wash cycle program and sensor inputs such as water temperature. The drain pump can be operated on and off as directed by the wash cycle program. The detergent/rinse aid dispenser can be energized during main wash in order to release detergent into the main wash.

The dishwasher controller determines the input variables, either directly or indirectly, as described above and in the following paragraphs. The dishwasher controller determines indirectly if the full flow filter placed before the suction of the wash pump is becoming clogged and therefore starving the wash pump of water. If the full flow filter becomes so clogged that water cannot pass through it at the same rate as the intake to the wash pump, the water level in the sump will fall and ultimately the wash pump will lose prime when air is drawn into the pump. When the pump loses prime, all wash action stops and the dishwasher's overall wash performance suffers significantly. The controller determines if the wash pump is losing prime by monitoring motor performance data from the motor controller. If the wash pump is losing prime then the expected torque load on the wash motor will drop below the range of expected values for the amount of water known to have been added to the dishwasher.

The rate of change of water temperature is determined by a thermistor located in such as way as to be in thermal communication with the wash water. The amount of food soil introduced is inferred by the state of the full flow filter. Up to the point where the full flow filter begins to become overwhelmed and clogged with food soil, the amount of food soil has a smaller effect on the wash performance. The critical level of food soil is reached when the filter can no longer pass enough water to keep the wash pump fully primed. The exact amount of water added to the dishwasher is provided by a water level sensor in the bottom of the sump. Since the shape and volume of the sump are known to high precision, the volume of water added to the machine can be computed from the depth of water measured by the level sensor.

The dishwasher control algorithm evaluates the amount of water added to the machine in conjunction with torque information from the motor controller to determine if the filter is becoming clogged and if valves should be closed or opened in order to dedicate more water to keeping the filter clear. If the pump is losing prime at less than a full fill volume, the pump speed can be slowed until enough water has been added for the wash pump to maintain full prime. If the full charge of water had been added and the pump still is detected to be losing prime, more water is dedicated to cleaning the filter by opening and closing flow control valves.

Because the overall heat transfer coefficient of the dishwasher is relatively constant and a known value along with the thermal power being added to the water by the water heater, the controller can infer the approximate thermal mass of the dishes loaded into the machine by measuring the rate of change of water temperature during the water heating as discussed above. If the thermal mass of the dish load is high, there is a higher probability that there is a large surface area on the dishes. The surface area of the dishes can be surprisingly high in a fully loaded dishwasher. A significant amount of water remains on the surface of the dishes during the wash cycle. If the surface area is high enough the amount of water needed to be added to the machine in order to keep the wash pump primed increases.

The dishwasher controller evaluates the filter data inferred from the motor controller along with the thermal mass data in order to determine if more water should be added to the machine if the pump loses prime during the wash cycle. If the thermal mass is low the probability that more water is required is much less and therefore the controller will only direct more water to be used to clean the filter. If the thermal mass is high, the probability that more water is required is higher; therefore, the controller will direct that more water be added to the dishwasher along with dedicating more water to the cleaning of the full flow filter.

If the thermal mass of the dishes is low and the incoming water temperature is relatively high, the controller can calculate a lower run time for the wash phase since an optimum wash water temperature will be reached sooner.

Controlling a dishwasher by evaluating these conditions has several advantages.

The amount of water used in each fill phase of the overall wash cycle will be reduced for most conditions. Because the dishwasher controller can determine the amount of water in the dishwasher and if the full flow filter is becoming clogged, a minimal amount of water can be added to the dishwasher and a maximum amount of the water added can be dedicated to washing the dishes instead of keeping the filter clean. If a heavy soil load is encountered, the dishwasher controller can determine how much water has been added to the machine by the level controller and if the filter is becoming clogged. If the filter is becoming clogged and the fill volume is complete, more water can be dedicated to keeping the filter clean. If the thermal mass is calculated to be high and the filter is becoming clogged, more water can also be added during the wash phase to compensate for the water which is covering the surface of the dishes.

Since the thermistor is measuring the rate of change of the water temperature, the approximate thermal mass of the dish load can be calculated along with the time which will be required to raise the water temperature to a desired level. If the time to reach the desired water temperature is longer than a predetermined value then the overall length of the wash cycle can be reduced since the prolonged wash action will increase the wash effectiveness of the cycle. This will reduce the overall cycle time and electrical energy consumed.

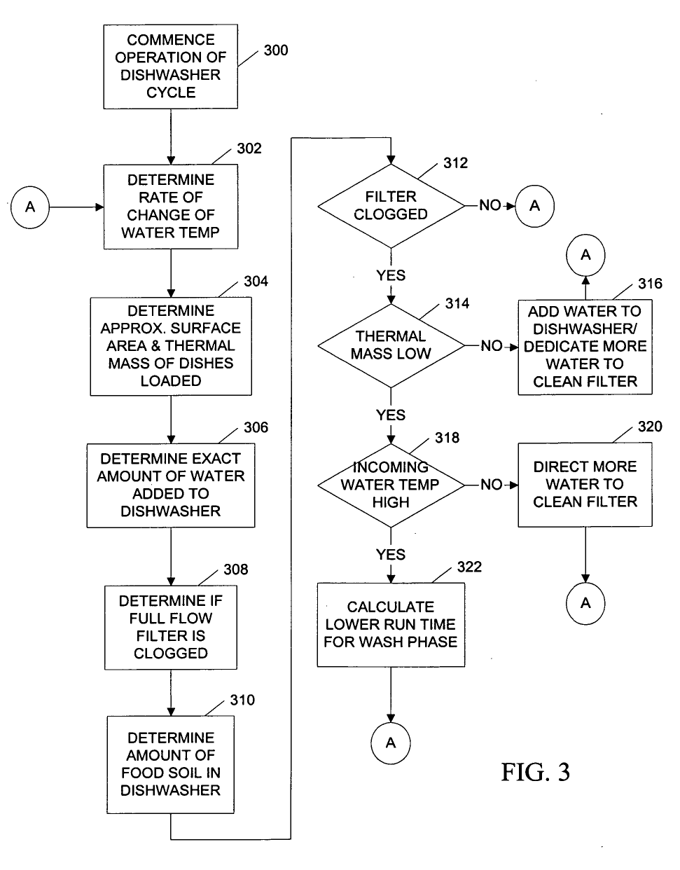

The exemplary processing logic (algorithm) executed by the dishwasher controller is illustrated in FIG. 3. The steps depicted are performed continuously during operation of the dishwasher. The sequence of steps depicted is for illustrative purposes only, and is not limiting in any way. The processing logic could be depicted in various other sequences with equal utility to the sequence depicted. Processing begins in logic block 300 with commencement of the dishwasher operating cycle. The rate of change of water temperature is determined as indicated in logic block 302. The approximate surface area and thermal mass of the loaded dishes is determined as indicated in logic block 304. The exact amount of water added to the dishwasher is then determined as indicated in logic block 306.

Next, a determination is made as to whether or not the full flow filter is clogged as indicated in logic block 308. The amount of food soil in the dishwasher is determined as indicated in logic block 310. In decision block 312, a determination is made as to whether or not the filter is clogged. If the filter is not clogged, processing logic returns to logic block 302 to repeat the process. If the filter is found to be clogged, a test is made in decision block 314 to determine if the thermal mass is low. If the thermal mass is not low (i.e., above a programmable threshold value), then water is added to the dishwasher and more water is dedicated to cleaning the filter as indicated in logic block 316. Processing then returns to logic block 302 to repeat the sequence of steps. If thermal mass is low, then a test is made in decision block 318 to determine if the incoming water temperature is higher than a predetermined value. If the water temperature is found to be high in decision block 318, a lower run time for the wash phase is determined as indicated in logic block 322. From this logic block, processing returns to logic block 302. If the water temperature is determined to be in an acceptable operational range in decision block 318, then more water is dedicated to cleaning the filter as indicated in logic block 320. Processing then returns to logic block 302 to repeat the sequence of steps.

Those skilled in the art will appreciate that many modifications to the preferred embodiment of the present invention are possible without departing from the spirit and scope of the present invention. In addition, it is possible to use some of the features of the present invention without the corresponding use of other features. Accordingly, the foregoing description of the preferred embodiment is provided for the purpose of illustrating the principles of the present invention and not in limitation thereof, since the scope of the present invention is defined solely by the appended claims.

What is claimed:

1. A dishwasher comprising:
a pump for discharging water into a dishwasher tub;
a motor coupled to the pump to drive the pump during dishwasher operation;
a motor controller operationally connected to the motor to control a speed of operation of the motor and to determine a filter condition; and
a dishwasher controller operationally connected to the motor controller for dynamically controlling the operation of the dishwasher in response to a plurality of conditions detected in the dishwasher during operation.

2. The dishwasher of claim 1 further comprising a detector for determining a fill level of the wash water in the dishwasher tub and providing the determined fill level to the dishwasher controller.

3. The dishwasher of claim 1 further comprising a thermistor for determining a temperature of the wash water in the dishwasher tub and providing the determined temperature to the dishwasher controller.

4. The dishwasher of claim 1 further comprising means for determining an approximate surface area and thermal mass of a plurality of dishes loaded in a rack of the dishwasher tub and providing the determined approximate surface area and thermal mass to the dishwasher controller.

5. The dishwasher of claim 1 further comprising means for determining an amount of food soil in the dishwasher and providing the determined amount of food soil to the dishwasher controller.

6. The dishwasher of claim 1 wherein the dishwasher controller comprises programming logic that receives and evaluates input signals representing the plurality of conditions detected, and determines if at least one condition detected requires a dynamic change in a controlled function.

7. The dishwasher of claim 6 wherein the at least one condition is the status of the filter.

8. The dishwasher of claim 7 wherein a low thermal mass condition is determined by the dishwasher controller and the response is a signal to add more wash water and to direct more wash water to clean the filter.

9. The dishwasher of claim 8 wherein if the thermal mass condition is above a threshold value and an incoming wash water temperature is determined to be higher than a predetermined value, the response is to determine a lower run time for a wash phase.

10. The dishwasher of claim 8 wherein if the thermal mass condition is above a threshold value and an incoming wash water temperature is determined to be in an acceptable range, the response is to direct more wash water to clean the filter.

11. A method for dynamically controlling operation of a dishwasher during a cleaning cycle, comprising the steps of:
detecting a plurality of conditions in the dishwasher during operation;
evaluating the plurality of detected conditions to determine a dynamic control response; and
sending a signal representing the dynamic control response to control at least one component of the dishwasher.

12. The method for dynamically controlling operation of a dishwasher of claim 11 wherein the plurality of detected conditions includes a rate of change of a wash water temperature.

13. The method for dynamically controlling operation of a dishwasher of claim 11 wherein the plurality of detected conditions includes an approximate surface area and thermal mass of a plurality of dishes loaded in the dishwasher.

14. The method for dynamically controlling operation of a dishwasher of claim 11 wherein the plurality of detected conditions includes an amount of wash water added to the dishwasher.

15. The method for dynamically controlling operation of a dishwasher of claim 11 wherein the plurality of detected conditions includes a status of a filter.

16. The method for dynamically controlling operation of a dishwasher of claim 11 wherein the plurality of detected conditions includes an amount of food soil in the dishwasher.

17. The method for dynamically controlling operation of a dishwasher of claim 11 further comprising sending a signal to add more wash water and to direct more wash water to clean the filter if the filter status is clogged and the thermal mass is low.

18. The method for dynamically controlling operation of a dishwasher of claim 11 further comprising sending a signal to direct more wash water to clean the filter if the filter status is clogged, the thermal mass is above a threshold value, and an incoming water temperature is in an acceptable range.

19. The method for dynamically controlling operation of a dishwasher of claim 11 further comprising sending a signal to reduce a run time for a wash phase of the dishwasher if the thermal mass is low and an incoming water temperature is higher than a predetermined value.

20. A control system for dynamically controlling operation of a dishwasher during a cleaning cycle comprising;
means for detecting a plurality of conditions in the dishwasher during operation;
means for evaluating the plurality of detected conditions to determine a dynamic control response; and
means for sending a signal representing the dynamic control response to control at least one component of the dishwasher.

21. The control system for dynamically controlling operation of a dishwasher of claim 20 wherein the means for detecting determines a rate of change of a wash water temperature.

22. The control system for dynamically controlling operation of a dishwasher of claim 20 wherein the means for detecting determines an approximate surface area and thermal mass of a plurality of dishes loaded in the dishwasher.

23. The control system for dynamically controlling operation of a dishwasher of claim 20 wherein the means for detecting determines an amount of wash water added to the dishwasher.

24. The control system for dynamically controlling operation of a dishwasher of claim 20 wherein the means for detecting determines a status of a filter.

25. The control system for dynamically controlling operation of a dishwasher of claim 20 wherein the means for detecting determines an amount of food soil in the dishwasher.

26. The control system for dynamically controlling operation of a dishwasher of claim 20 wherein the means for sending sends a signal to add more wash water and to direct more wash water to clean the filter if the filter status is clogged and the thermal mass is low.

27. The control system for dynamically controlling operation of a dishwasher of claim 20 wherein the means for sending sends a signal to direct more wash water to clean the filter if the filter status is clogged, the thermal mass is above a threshold value, and an incoming water temperature is in an acceptable range.

28. The control system for dynamically controlling operation of a dishwasher of claim 20 wherein the means for sending sends a signal to reduce a run time for a wash phase of the dishwasher if the thermal mass is low and an incoming water temperature is higher than a predetermined value.
